(19) United States
(12) Patent Application Publication
(10) Pub. No.: US 2024/0170771 A1
(43) Pub. Date: May 23, 2024

(54) BATTERY PACKAGING MATERIAL

(71) Applicant: Resonac Packaging Corporation, Hikone-shi (JP)

(72) Inventor: Keitaro KAWAKITA, Hikone-shi (JP)

(73) Assignee: Resonac Packaging Corporation, Hikone-shi (JP)

(21) Appl. No.: 18/426,377

(22) Filed: Jan. 30, 2024

Related U.S. Application Data
(63) Continuation of application No. PCT/JP2022/024514, filed on Jun. 20, 2022.

(30) Foreign Application Priority Data
Jul. 30, 2021 (JP) 2021-124948

(51) Int. Cl. H01M 50/129; H01M 50/119; H01M 50/121; H01M 50/124; H01M 50/136

(52) U.S. Cl. CPC H01M 50/129; H01M 50/119; H01M 50/121; H01M 50/1245; H01M 50/136

(57) ABSTRACT

In a battery packaging material in which a substrate protective layer, a substrate layer, a barrier layer, and a heat-fusible resin layer are laminated in this order, the substrate protective layer is formed of a resin composition containing a resin component and solid fine particles. The Young's modulus of the substrate protective layer measured by a method specified in JIS K7127 is 0.5 MPa to 3 MPa, and the tensile strength at 40% elongation measured by a method specified in JIS K7127 is 5 MPa to 20 MPa.

### CROSS-REFERENCE TO RELATED APPLICATIONS

The present application is a continuation application of International Application No. PCT/JP2022/024514, filed on Jun. 20, 2022, which claims priority to Japanese Patent Application No. 2021-124948, filed on Jul. 30, 2021, the contents of which are incorporated herein by reference in its entirety.

### BACKGROUND OF THE INVENTION

### Technical Field

The present disclosure relates to a battery packaging material and a battery. More specifically, the battery packaging material is suitably used, but not limited to, as a packaging case for a secondary battery for, e.g., an automotive use, a stationary use, a laptop computer, a cellular phone, or a camera, especially suitable for use as a small portable lithium-ion secondary battery.

### Description of the Related Art

The following description sets forth the inventor's knowledge of related art and problems therein and should not be construed as an admission of knowledge in the prior art.

During a battery production process, when a surface of a packaging material, which is a case material, is damaged, the appearance of the product is impaired. In order to prevent the occurrence of appearance defects during the production process, a measure is taken in which a protective tape is adhered to the packaging material, and the protective tape is peeled off after completion of the production process. The above-described protective tape is required to have adhesiveness that does not allow peeling during the production process, but when it is firmly adhered, the adhesive of the protective tape may remain on the packaging material after removal. Further, in a packaging material in which a coloring layer containing carbon black is laminated on the surface of the packaging material, the coloring layer may be peeled off along with the protective tape.

Conventionally, to deal with such a problem related to a protective tape, the adhesive residue after removal of the protective tape was dealt with by the adhesive strength of the protective tape (see Patent Document 1). Further, as for peeling of a coloring layer, a technique for strengthening the coloring layer has been proposed (see Patent Document 2).

### PRIOR ART DOCUMENT

### Patent Document

Patent Document 1: Japanese Unexamined Patent Application Publication No. 2020-155364
Patent Document 2: Japanese Unexamined Patent Application Publication No. 2006-206805

### SUMMARY OF THE INVENTION

However, the technique described in Patent Document 1 is not a preventive measure against adhesive residue in a packaging material. Further, the technique described in Patent Document 2 does not solve the problem of adhesive residue for a packaging material in which the outermost layer is not a coloring layer containing carbon black.

The present disclosure has been made to solve such problems, and the purpose of the present disclosure is to impart conflicting characteristics that a protective tape does not peel off unintentionally and can be peeled off without remaining adhesive of the protective tape on a surface of a battery packaging material.

A battery packaging material according to a first aspect of the present disclosure includes:
a substrate protective layer;
a substrate layer;
a barrier layer; and
a heat-fusible resin layer,
wherein the substrate protective layer, the substrate layer, the barrier layer, and the heat-fusible resin layer are laminated in this order,
wherein the substrate protective layer is composed of a resin composition containing a resin component and solid fine particles, and
wherein the Young's modulus of the substrate protective layer measured by a method specified in JIS K7127 is 50 MPa to 300 MPa, and tensile strength at 40% elongation measured by a method specified in JIS K7127 is 5 MPa to 20 MPa.

A battery according to a second aspect of the present disclosure includes
a bare cell, and
a battery case made of the battery packaging material described above,
wherein the bare cell is encapsulated in the battery case, and
wherein the battery case is formed by heat-sealing peripheral portions of a pair of the battery packaging materials stacked one on the other with the heat-fusible resin layers faced each other.

The above and other objects, features, aspects, and advantages of the present disclosure will become apparent from the following detailed description of the present disclosure understood in connection with the accompanying drawings.

### BRIEF DESCRIPTION OF THE DRAWINGS

Some embodiments of the present disclosure are shown by way of example, and not limitation, in the accompanying figures.

FIG. 1 is a cross-sectional view showing one embodiment according to a battery packaging material of the present disclosure.

FIG. 2 is a cross-sectional view showing another embodiment according to a battery packaging material of the present disclosure.

FIG. 3 is S-S curves each showing the relation between stress and elongation of a cured film of a resin composition.

FIG. 4 is a cross-sectional view of a battery case produced using the battery packaging material shown in FIG. 1.

### EMBODIMENTS FOR CARRYING OUT THE INVENTION

In the following paragraphs, some preferred embodiments of the present disclosure will be described by way of example and not limitation. It should be understood based on this disclosure that various other modifications can be made by those in the art based on these illustrated embodiments

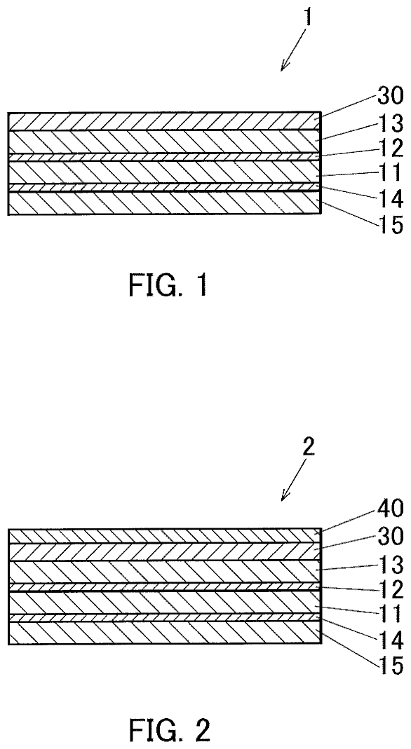

FIG. 1 and FIG. 2 show two embodiments of the battery packaging material of the present disclosure.

In the following description, a layer assigned by the same reference symbol represents the same or equivalent layer, and therefore, the duplicate description thereof will be omitted.

### First Embodiment of Battery Packaging Material

In the battery packaging material 1 shown in FIG. 1, a substrate layer 13 is laminated on one side of a barrier layer 11 via a first adhesive layer 12, a heat-fusible resin layer 15 is laminated on the other side via a second adhesive layer 14, and a substrate protective layer 30 is laminated on the substrate layer 13.

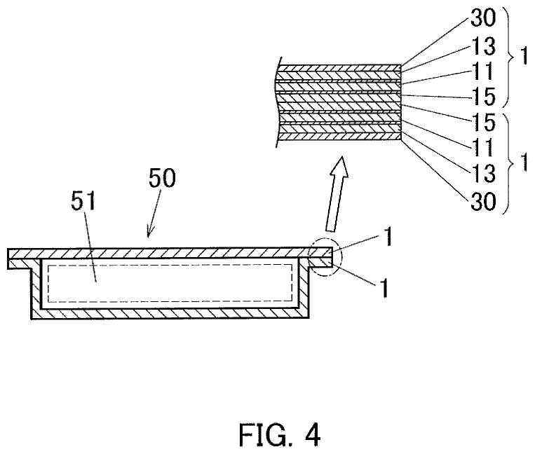

As shown in FIG. 4, a pair of the battery packaging materials 1 is stacked one on the other with the heat-fusible resin layers 15 faced each other in a state in which a bare cell 51 is disposed between the pair of the battery packaging materials 1, and the peripheries of the battery packaging materials 1 are heat-sealed to produce a battery case 50. Thus, the bare cell 51 is encapsulate and sealed inside the battery case 50. In the battery case 50, the substrate protective layer 30 is arranged on the outer side, and the heat-fusible resin layer 15 is arranged on the inner side. In this specification, when describing the position of each layer constituting the battery packaging material in terms of direction, in accordance with the direction toward the inner side of the battery case and the direction toward the outer side of the battery case, the direction toward the substrate protective layer will be referred to as an outer side, and the direction toward the heat-fusible resin layer will be referred to as an inner side.

The outer surface of the battery packaging material 1 is required to have conflicting characteristics that an adhered protective tape is required to be firmly attached to the outer surface of the battery packaging material without causing unintentional peeling. However, when the protective tape becomes unnecessary, the protective tape can be cleanly peeled off without leaving any adhesive of the protection tape on the adhered surface and without damaging the adhered surface.

### (Substrate Protective Layer)

The substrate protective layer 30 is a layer for imparting good slipperiness to the surface of the battery packaging material to improve moldability, as well as for imparting excellent electrolyte resistance, chemical resistance, solvent resistance, and abrasion resistance.

A protective tape to be adhered to the substrate protective layer 30 is supposed to be peeled off, so its adhesive is soft. The substrate protective layer 30 is a cured film of a resin composition containing resin components and solid fine particles, so the hardness differs depending on the composition of the resin composition and other factors. In a case where a protective tape is adhered to such a substrate protective layer 30, surface cracking is likely to occur when the substrate protective layer 30 is too hard, causing soft adhesive to permeate into the cracked portions, resulting in adhesive residue. On the other hand, in a case where the substrate protective layer 30 is too soft, the adhesiveness between the protective tape and the substrate protective layer 30 becomes excessive, and when peeling off the protective tape, a part of the substrate protective layer 30 (curing film) is taken by the adhesive agent, which causes easy film peeling. Therefore, it is conceivable that a protective tape can be peeled off cleanly without damaging the substrate protective layer 30 and without leaving behind any adhesive by setting the substrate protective layer 30 to have an appropriate hardness.

In the present disclosure, the hardness of the substrate protective layer 30 is specified by the Young's modulus and the tensile strength at 40% elongation measured by the method specified in JIS K7127. The Young's modulus is 50 MPa to 300 MPa, and the tensile strength at 40% elongation is 5 MPa to 20 MPa. The more preferred Young's modulus is 70 MPa to 250 MPa, and the more preferred tensile strength at 40% elongation is 5 MPa to 15 MPa.

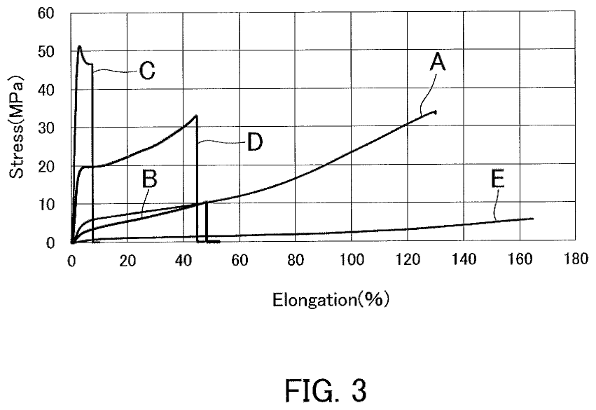

FIG. 3 is an example of S-S curves (stress-strain curves) showing the relation between tensile strength (stress) (MPa) and elongation (strain) (%) of cured films A-E of five types of resin compositions different in composition. As shown in tis figure, the cured films stretch in various patterns, but in the present disclosure, hardness is determined based on the tensile strength (stress) at 40% elongation (at 40% strain amount). Among the five types of cured films of the illustrated example, A and B meet the requirements of the present disclosure.

Further, the substrate protective layer 30 is preferably to have surface glossiness of 6.0 GU or less.

The substrate protective layer 30 contains solid fine particles, and therefore, unevenness is formed on the surface of the substrate protective layer. A protective tape comes into contact with the protrusions but are separated at the recesses, and therefore, the effective contact area with the substrate protective layer 30 of the protective tape becomes smaller. As a result, the peelability of the protective tape is improved, thereby causing less adhesive residue. The less unevenness and the smoother the surface of the substrate protective layer 30, the higher the surface glossiness, and the more unevenness and the lower the surface glossiness. The more unevenness, the less contact area with a protective tape, so the degree of adhesive residue can be estimated by the surface glossiness. In the present disclosure, it is recommended that the surface glossiness of the substrate protective layer be less than 6.0 GU. The particularly preferred surface glossiness is 5.0 or less.

In the substrate protective layer 30, the preferred resin component and solid fine particles are as follows.

As the resin component, it is preferable to use at least one type of the following resins: an acrylic-based resin; an epoxy resin; a urethane-based resin; a polyolefin-based resin; a fluorine-based resin; and a phenoxy resin. Since these resins are high in chemical and solvent resistance, the solid fine particles are less likely to drop off due to resin degradation, etc., which enables assured forming of surface unevenness. And the surface of the substrate protective layer 30 with unevenness can fully demonstrate the effect of reducing the contact area with a protective tape, thereby reducing adhesive residue.

Further, the resin component may be a base resin containing at least one of the above-mentioned resins and a curing agent that cures the base resin.

Further, the hardener is not particularly limited and may be appropriately selected according to the main resin. In the case where the base resin is a mixture of a urethane-based resin and a phenoxy-based resin, it is preferable to use an isocyanate compound. As the isocyanate compounds, various polyfunctional polyfunctional isocyanate compounds of aliphatic, alicyclic, and aromatic isocyanate types can be recommended. As the aliphatic polyfunctional isocyanate compound, hexamethylene diisocyanate (HDI), etc., can be exemplified. As the alicyclic polyfunctional isocyanate compound, isophorone diisocyanate (IPDI), etc., can be exemplified. As the aromatic polyfunctional isocyanate compound, tolylene diisocyanate (TDI), diphenylmethane diisocyanate (MDI), etc., can be exemplified. They may also be modified products of these polyfunctional isocyanurate compounds, and the examples thereof include polyfunctional isocyanate modified products by multimerization reactions such as isocyanurate, carbodiimide, and polymerization.

The curing agent is preferably blended from 5 parts by mass to 30 parts by mass with respect to 100 parts by mass of the main resin. When the curing agent is less than 5 parts by mass, the adhesiveness to the substrate layer 13 and the solvent resistance may deteriorate. Further, when the curing agent exceeds 30 parts by mass, the substrate protective layer 30 may become harder, resulting in reduced moldability. The particularly preferred curing agent amount is 10 to 20 parts by mass with respect to 100 parts by mass of the base resin. The hardness of the substrate protective layer 30, i.e., the Young's modulus and the tensile strength at 40% elongation, is affected by the mixing ratio between the base resin and the curing agent, so the amount of the base resin and that of the curing agent are set so that the desired hardness is obtained.

Of the resin components described above, the particularly preferred resin components are compounds of a main agent containing a phenoxy resin and a urethane resin and a curing agent (isocyanate). A urethane resin and a phenoxy resin differ in softness, and when solid fine particles are included, there are three different hardness portions in the cured film of the resin composition. When peeling off a protective tape, the adhesive quickly leaves the surface of the curing film at its hard portions and slowly leaves the surface at its soft portions. It is considered that the adhesive of a protective tape leaves the surface of the curing film with slight timing deviations, so the force applied to the adhesive (layer of the adhesive) is dispersed, making the cohesive breakdown of the adhesive less likely to occur, which results in less adhesive residue. Further, the Young's modulus and the stress at 40% elongation of the substrate protective layer 30 are defined, and the entire surface of the cured film has moderate hardness, so it is considered that the rapid release of the adhesive on the entire surface of the cured film also contributes to suppressing the occurrence of adhesive residue.

From the viewpoint of generating the above-mentioned timing gap for the adhesive release, the preferred ratio of the phenoxy resin to the urethane resin is 0.5 to 5.0 of urethane resin to 1 of phenoxy resin 1, by mass. Further, the more preferred ratio is 1.3 to 4.1 of urethane resin to 1 of phenoxy resin.

In the present disclosure, the solid fine particles contribute to the suppression of adhesive residue by forming unevenness on the surface of the substrate protective layer 30, as described above. Further, the solid fine particles are components to be added to improve the moldability by imparting slippiness to the substrate protective layer 30 and adjust the surface glossiness. For the solid fine particles that produce these effects, either inorganic fine particles or organic fine particles may be used, and their mixture can also be used. As the inorganic fine particles, silica, alumina, calcium oxide, calcium carbonate, calcium sulfate, calcium silicate, carbon black, etc., can be exemplified. As the organic fine particles, acrylic ester-based compounds, polystyrene-based compounds, epoxy-based resins, polyamide-based compounds, or their crosslinking compounds thereof can be used. One type or a mixture of two or more types of the above-described solid fine particles can be used.

These solid fine particles are preferably 1 μm to 10 μm, particularly 2 μm to 5 m, in average particle diameter. When solid fine particles with a too-small particle diameter of less than 1 μm are used, they are buried in the coating solution, which makes it difficult to obtain the desired properties. On the other hand, when solid fine particles with a particle diameter larger than 10 μm are used, the particle diameter exceeds the coating thickness, which causes the solid fine particles to easily drop off from the substrate protective layer.

Further, the content rate of the solid fine particles in the resin composition is appropriately determined in the range of 0.1 mass % to 60 mass %, depending on the surface glossiness, the slipperiness, the particle size, and the type of the fine particles to be added, and other factors. When the content rate is less than 0.1 mass % or more than 60 mass %, it is difficult to obtain the desired surface glossiness and slipperiness. The preferred content range of the solid fine particles is a range of 5 mass % to 55 mass %, particularly in a range of 20 mass % to 50 mass %.

The thickness of the substrate protective layer 30 after curing is preferably 1 μm to 10 μm. A layer thinner than the lower limit has little effect on improving slipperiness. When the amount of the solid fine particles is increased to improve the slipperiness, the solid fine particles become more likely to drop off, and the coating film becomes brittle. On the other hand, when the layer is thicker than the upper limit, the amount of residual solvent after curing increases, which leads to easy blocking and insufficient drying in the center portion of the coating film, resulting in the brittleness of the coating film. Besides, the formation of a thick layer increases costs. The particularly preferred thickness of the substrate protective layer 30 is in the range of 2 μm to 5 μm.

Note that the present disclosure does not exclude components other than the resin components and solid fine particles mentioned above as components of the resin composition constituting the substrate protective layer 30, and the addition of other components is permitted as long as the characteristics of the substrate protective layer 30 are not impaired. For example, by adding a lubricant, a battery packaging material with a lubricant layer can be produced on the substrate protective layer 30 (see FIG. 2). A battery packaging material with a lubricant layer will be described in detail later.

In the battery packaging material 1 described above, preferred materials for the layers other than the substrate protective layer 30 are as follows.

### (Barrier Layer)

The barrier layer 11 plays a role in imparting gas barrier properties that prevent intrusion of oxygen and moisture to the battery packaging material 1. As the barrier layer 11, although not particularly limited, a metal foil, such as, e.g., an aluminum foil, a SUS foil (stainless steel foil), a copper foil, a nickel foil, a titanium foil, and a clad foil, can be exemplified. The thickness of the barrier layer 11 is preferably 20 μm to 100 km. A thickness of 20 μm or more can prevent the occurrence of pinholes during rolling when producing a metallic foil, and a thickness of 100 μm or less can reduce the stress during molding, such as, e.g., stretch forming and drawing, which can improve the moldability. The particularly preferred thickness of the barrier layer 11 is 25 μm to 85 km.

Further, the barrier layer 11 is preferably subjected to a surface treatment, such as, e.g., a chemical conversion treatment, on at least the heat-fusible resin layer 15 side of the metallic foil. Such a chemical conversion treatment sufficiently prevents corrosion of the metal foil surface due to the contents (electrolyte of batteries, etc.).

### (Substrate Layer)

As the substrate layer 13, a heat-resistant resin film that does not melt at the heat-sealing temperature when heat-sealing the battery packaging material 1 is used. As the heat-resistant resin, a heat-resistant resin having a melting point higher than the melting point of the resin constituting the heat-fusible resin layer 15 by 10° C. or more, preferably 20° C. or more, is used. As the resin that meets these conditions, a polyamide film such as a nylon film, and a polyester film, can be exemplified, and these stretched films are preferably used. Among them, as the substrate layer 13, it is particularly desirable to use a biaxially stretched polyamide film, such as, e.g., a biaxially stretched nylon film, a biaxially stretched polybutylene terephthalate (PBT) film, a biaxially stretched polyethylene terephthalate (PET) film, and a biaxially stretched polyethylene naphthalate (PEN) film. As the nylon film, although not particularly limited, a 6 nylon film, a 6,6 nylon film, an MXD nylon film, etc., can be exemplified. Note that the substrate layer 13 may be formed as a single layer. Alternatively, it may be formed, for example, as a multilayer composed of a polyester film/a polyamide film (e.g., a multilayer, etc., composed of a PET film/a nylon film).

The thickness of the substrate layer 13 is preferably 9 μm and 50 μm, which can ensure sufficient strength as a packaging material and reduce the stress during molding, such as, e.g., stretch forming and drawing, thereby improving the moldability. The more preferred thickness of the substrate layer 13 is 9 μm to 30 μm.

### (Heat-Fusible Resin Layer)

The heat-fusible resin layer 15 plays a role in providing the battery packaging material 1 with excellent chemical resistance to highly corrosive electrolytes and other substances, as well as heat-sealing property.

The resin constituting the heat-fusible resin layer 15 is preferably a polyolefin-based resin, and a non-stretched film thereof is preferred. As the propylene-based resin, an ethylene-propylene copolymer containing ethylene and propylene as copolymerization components can be exemplified. The ethylene-propylene copolymer may be either a random copolymer or a block copolymer. Further, the heat-fusible resin layer 15 may be either a single film or a multilayer film. As the multilayer ethylene-propylene copolymer film, a three-layer film of random copolymer-block copolymer-random copolymer can be recommended. The multilayer film can be produced by co-extrusion or other methods.

The thickness of the heat-fusible resin layer 15 is preferably 20 μm to 100 μm, more preferably 25 μm to 80 μm. Further, the thickness ratio of each layer of the three-layer film made of a random copolymer-a block copolymer-a random copolymer is preferably 1-3: 4-8:1-3, when the total thickness is 10.

Note that the heat-fusible resin layer may contain a lubricant. By adding a lubricant to the heat-fusible resin layer 15, a battery packaging material with a lubricant layer on the substrate protective layer 30 can be produced (see FIG. 2). A battery packaging material with a lubricant layer will be described in detail later.

### (First Adhesive Layer)

The first adhesive layer 12 is not particularly limited but can be exemplified by an adhesive layer made of a two-part curable adhesive. As the two-part curing type adhesive, it can be exemplified by a two-part curing type adhesive composed of a first liquid (main agent) composed of one or more types of polyols selected from the group consisting of a polyurethane-based polyol, a polyester-based polyol, a polyether-based polyol, and a polyester urethane-based polyol, and a second liquid (curing agent) composed of an isocyanate. Among them, it is preferable to use a two-part curing type adhesive composed of a first liquid and a second liquid, wherein the first liquid is one or more types of polyols selected from the group consisting of a polyester-based polyol and a polyester urethane-based polyol, and the second liquid (curing agent) is composed of isocyanate. The preferred thickness of the first adhesive layer 12 is 2 μm to 5 μm.

### (Second Adhesive Layer)

The second adhesive layer 14 is not particularly limited but can be recommended to use, for example, an adhesive containing one or more types of polyurethane-based resin, an acrylic-based resin, an epoxy-based resin, a polyolefin-based resin, an elastomer-based resin, a fluorine-based resin, and an acid-modified polypropylene resin. Among them, it is preferred to use an adhesive composed of a polyurethane composite resin with an acid-modified polyolefin as the main ingredient. The preferred thickness of the second adhesive layer 14 is 2 μm to 5 μm.

The first adhesive layer 12 and the second adhesive layer 14 are not essential layers. The substrate layer 13 may be directly bonded to the barrier layer 11, or the heat-fusible resin layer 15 may be directly bonded to the barrier layer 11.

### Second Embodiment of Battery Packaging Material

In the battery packaging material 2 shown in FIG. 2, a substrate protective layer 30, a substrate layer 13, a first adhesive layer 12, a barrier layer 11, a second adhesive layer 14, and a heat-fusible resin layer 15 are sequentially laminated, and a lubricant layer 40 is formed on the outer side of the substrate protective layer 30. That is, it differs from the battery packaging material 1 shown in FIG. 1 in that the lubricant layer 40 is added as the outermost layer.

### (Lubricant Layer)

The lubricant constituting the lubricant layer 40 has the effect of reducing the adhesive force of the adhesive of the protective tape. By interposing the lubricant layer 40 between the substrate protective layer 30 and a protective tape, the peeling properties of the protective tape are improved, thereby causing less adhesive residue. Further, the moldability of the battery packaging material 2 can be improved by forming the lubricant layer 40. Note that the lubricant of the present disclosure includes those referred to as a surfactant, as well as those referred to as a lubricant such as amide. This is because the surfactant described above also reduces the adhesiveness of the adhesive and can be used in the same manner as amides and other surfactants. A lubricant (including a surfactant) suitable for the lubricant layer 40 of the present disclosure is as follows.

As a saturated fatty acid amide, a lauramide, a palmitamide, a stearamide, behen amide, and hydroxystearic acid amide can be exemplified.

As an unsaturated fatty acid amide, an oleamide and an erucamide can be exemplified.

As a substituted amide, an N-oleoyl palmitamide, an N-stearyl stearamide, n N-stearyl oleamide, an N-Oleoyl stearamide, an N-Stearyl erucamide can be exemplified.

As the methylolamide, a methylol stearamide can be exemplified.

As the saturated fatty acid bisamide, a methylene bisstearamide, an ethylene biscaprate amide, an ethylene bislauramide, an ethylene bisstearamide, an ethylene bishydroxystearamide, an ethylene bisbehenamide, and a hexamethylene bisstearaamide, a hexamethylene biabehenamide, a hexamethylene hydroxystearamide, an N,N′-distearyl adipic acid amide, and an N,N′-distearyl sebacic acid amide, can be exemplified.

As the unsaturated fatty acid bisamide, an ethylene bisoleamide, an ethylene bisercamide, a hexamethylene bisoleamide, an N,N′-dioleoyl adipic acid amide, and an N,N′-dioleoyl sebacic acid amide can be exemplified.

As the fatty acid ester amide, stearamide ethyl stearate can be exemplified.

As the aromatic bisamide, an m-xylylene bistearamide, an m-xylylene bis-hydroxystearamide, and an N,N′-distearylisophthalamide can be exemplified.

Furthermore, as the surfactant, an anionic-based surfactant, a cationic-based surfactant, and a nonionic-based surfactant can be exemplified.

The lubricant layer 40 may contain a solvent for a density adjustment in addition to the lubricant described above.

The lubricant amount in the lubricant layer 40 is preferably 1.0 mg/m² to 10.0 mg/m². When the lubricant amount is less than the lower limit, the effect of preventing the occurrence of adhesive residue and the effect of improving the moldability are small. On the other hand, when the amount is greater than the upper limit, the adhesiveness with the protective tape may deteriorate, causing unintentional peeling and generation of white powder during the molding. The white powder is a lubricant precipitated on the surface of the layer. The lubricant amount of 1.0 mg/m² to 5.0 mg/m² is even more preferable.

The method of forming the lubricant layer 40 is not specifically limited and may be any of the following methods.

(1) A lubricant is applied to the surface of the substrate protective layer 30 and dried to thereby form a lubricant layer 40. The merits of this formation method are that the prescribed lubricant amount can be assuredly applied and that the lubricant layer 40 can be assuredly formed on a laminate of a laminate sheet type.

(2) A lubricant is made to be contained in the heat-fusible resin layer 15, and the lubricant is transferred from the heat-fusible resin layer 15 to the surface of the substrate protective layer 30 to thereby form the lubricant layer 40.

Specifically, the lubricant is made to be impregnated in the heat-fusible resin layer 15, and the substrate protective layer 30, the substrate layer 13, the first adhesive layer 12, the barrier layer 11, the second adhesive layer 14, and the heat-fusible resin layer 15 are laminated in sequence to make an intermediate layer, and this intermediate layer is rolled onto a roll shaft. In the intermediate layer laminate rolled on the roll shaft, the heat-fusible resin layer 15 is in contact with the substrate protective layer 30. Therefore, it is aged in this state to cause the lubricant precipitated on the surface of the heat-fusible resin layer 15 to be adhered to the surface of the substrate protective layer 30 to thereby form the lubricant layer 40. That is, by transferring the lubricant precipitated on the surface of the heat-fusible resin layer 15 to the substrate protective layer 30, the lubricant layer 40 is formed. The advantage of this formation method is that no special lubricant layer formation process is required. That is, the aging after laminating the barrier layer 11, the substrate layer 13, the heat-fusible resin layer 15, and the substrate protective layer 30 is a normal process performed to stabilize the adhesive layer in a conventional production of a battery packaging material not having a lubricant layer, and this aging stabilizes the adhesive layer and simultaneously forms the lubricant layer 40.

When forming the lubricant layer 40 by the method described above, the concentration of the lubricant in the heat-fusible resin layer 15 is preferably set to 500 ppm to 3,000 ppm. When the lubricant concentration is lower than the lower limit, since the transfer amount to the substrate protective layer 15 is small, it is difficult to form a sufficient lubricant layer 40, and the effect of improving moldability by adding a lubricant to the heat-fusible resin layer 15 is also small. When the lubricant concentration is higher than the upper limit, white powder is more likely to be generated, which may cause the amount transferred to the substrate protective layer 30 to be excessive. The concentration of the lubricant in the heat-fusible resin layer 15 is more preferred when it is 700 ppm to 3,000 ppm.

Note that the lubricant layer 40 can be formed by applying a lubricant to the substrate protective layer 30, so the presence or absence of the lubricant in the heat-fusible resin layer 15 and the optimum concentration of the lubricant depends on the method used to form the lubricant layer 40.

(3) A lubricant is made to be contained in the substrate protective layer 30 to cause the lubricant to be precipitated on the surface, thereby forming the lubricant layer 40.

It is preferable to set the concentration of the lubricant in the resin composition constituting the substrate protective layer 30 to 1,000 ppm to 20,000 ppm. When the concentration of the lubricant is lower than the lower limit, the precipitation amount is small, and the effect of suppressing the occurrence of adhesive residue by the lubricant layer 40 is small, and therefore, the effect of improving the moldability is also small. On the other hand, when the lubricant concentration is greater than the upper limit, the precipitation amount is excessive, resulting in poor adhesiveness of the protective tape and easy generation of white powder. The concentration of the lubricant in the substrate protective layer 30 is even more preferable when it is 6,000 ppm to 18,000 ppm.

### EXAMPLES

Battery packaging materials of Examples and Comparative Examples were produced. Materials common to Examples are as follows.

### (Common Materials)

As the barrier layer 11, a layer was used in which a chemical conversion treatment solution composed of phosphoric acid, polyacrylic acid (acrylic-based resin), a chromium (III) salt compound, water, and alcohol was applied to both sides of an aluminum foil made of A8021-O with a thickness of 40 μm, and then dried at 180° C. to form a chemical conversion coating. The chromium adhesion amount of this chemical conversion coating was 10 mg/m² per side.

As the substrate layer 13, a biaxially stretched 6-nylon film with a thickness of 15 μm was used.

As the heat-fusible resin layer 15, a non-stretched polypropylene film of 40 μm thickness was used. Further, in Examples 1-13 and Comparative Examples 1-3, a non-stretched film in which erucamide (EA), oleamide (OA), or anionic surfactant (AN) was added as a lubricant for forming the lubricant layer at the concentrations shown in Table 1 was used.

As the first adhesive layer 12, a two-part curing type urethane-based adhesive was used.

As the second adhesive layer 14, a two-part curing type maleic acid-modified propylene adhesive was used.

### Examples 1-9, 12, 13, Comparative Examples 1-2

A battery packaging material 2 with the laminated structural material shown in FIG. 2 was prepared.

A resin composition for forming the substrate protective layer 30 was prepared by the following method. A polyester polyol resin was used as the main resin, and a mixture of tolylene diisocyanate (TDI) and hexamethylene diisocyanate (HDI) in a mass ratio of 1:1 was used as a curing agent. A resin component was prepared by blending the curing agent in the amounts shown in Table 1 with the base resin of 100 parts by mass. And silica with an average particle diameter of 2 μm was blended with the resin component described above so that the content in the resin composition became the content shown in Table 1 and dispersed uniformly.

First, a first adhesive layer 12 with a thickness of 3 μm was formed on one side of the barrier layer 11, and a substrate layer 13 was dry-laminated via the first adhesive layer 12. Next, a second adhesive layer 14 with a thickness of 3 μm was formed on the other side of the barrier layer 11, and a heat-fusible resin layer 15 was overlaid via this second adhesive layer 14 and dry-laminated by sandwiching it between a rubber nip roll and a laminate roll heated to 100° C. and then crimping it. This resulted in a three-layer laminated film.

Next, the resin composition for forming the substrate protective layer 30 described above was applied to the surface of the substrate layer 13 of the three-layer laminated film and dried. The thickness of the substrate protective layer 30 after drying was 4 m. This resulted in a four-layer film, and the four-layer film was wound onto a roll shaft. In the rolled four-layer film, the substrate protective layer 30 was in contact with the heat-fusible resin layer 15, and the film was aged at 40° C. for 10 days in this state.

Then, the lubricant was precipitated from the heat-fusible resin layer 15 during the aging described above, and the precipitated lubricant was transferred to the surface of the substrate protective layer 30 to thereby form the lubricant layer 40.

### Example 10

A battery packaging material 2 with the laminated structural material shown in FIG. 2 was prepared.

A resin composition for forming the substrate protective layer 30 was prepared by the following method. A mixture of polyester polyol and phenoxy polyol in a mass ratio of 4:1 was used as the base resin. A mixture of tolylene diisocyanate (TDI) and hexamethylene diisocyanate (HDI) at a mass ratio of 1:1 was used as the curing agent. The mixture of the curing agent of 10 parts by mass with the base resin of 100 parts by mass was used as the resin component. And silica with an average particle diameter of 2 μm was blended with the resin component described above so that the content in the resin composition became the content shown in Table 1, and mixed uniformly.

A battery packaging material was prepared in the same manner as in Example 1 except for the composition of the substrate protective layer 30.

### Example 11

A battery packaging material 2 with the laminated structural material shown in FIG. 2 was prepared.

A battery packaging material was prepared by the same manner as in Example 1 except that in the resin composition for forming the substrate protective layer 30, silica was replaced with acrylic beads with an average particle diameter of 2 μm.

### Example 14

A battery packaging material 1 with the laminated structural material shown in FIG. 1 was prepared.

A battery packaging material was prepared in the same manner as in Example 1 except that no lubricant was added to the resin composition for forming the heat-fusible resin layer 15. Therefore, the battery packaging material in this example does not have a lubricant layer 40 on the surface of the substrate protective layer 30.

### Comparative Example 3

A resin composition for forming the substrate protective layer 30 was prepared by the following method. An epoxy resin compound was used as the main resin, a polyamine compound was used as the curing agent, and a mixture of 10 parts by mass of a curing agent to 100 parts by mass of a base resin was used as the resin component. And silica with an average particle diameter of 2 μm was blended with the resin component described above so that the content in the resin composition became the content shown in Table 1, and uniformly dispersed.

A battery packaging material was prepared in the same manner as in Example 1 except for the composition of the substrate protective layer 30.

For the prepared battery packaging material, the Young's modulus and the tensile strength at 40% elongation of the substrate protective layer 30, the surface glossiness (GU value), and the lubricant amount of the lubricant layer 40 were measured, and the tape adhesiveness and the appearance after tape peeling were evaluated according to the following methods. Table 1 shows the results.

### (Young's Modulus and Tensile Strength of Substrate Protective Layer)

The Young's modulus (MPa) and the tensile strength at 40% elongation (MPa) of the cured film made by thermally curing the resin composition constituting each substrate protective layer 30 used in Examples and Comparative Examples were measured according to JIS K7127-1999.

Specifically, after applying each resin composition at a thickness of 50 μm on a glass plate, the resin composition was subjected to heat aging processing at 40° C. for 11 days to thermally cure the resin composition to obtain a cured film of 48 μm in thickness. After peeling the cured film from the glass plate, it was cut into a piece of 15 mm wide×100 mm long to make a test piece, and Shimadzu Strograf (AGS-5kNX) was used to perform a tensile test of the test piece at a tensile speed of 200 mm/min to determine the Young's modulus (MPa) and the tensile strength (MPa) at 40% elongation were measured.

### (Lubricant Amount in Lubricant Layer)

The battery packaging material was cut into a piece of 10 cm×10 cm and used as a test material. The test piece was folded in half (5 cm×10 cm) so that the lubricant layer (substrate protective layer in Comparative Example 4) was on the inner side layer, and the two sides of 5 cm were sealed over the heat-fusible resin layer via a PET film to produce a bag. 1 mL of acetone was placed inside the bag and left for 3 minutes with the acetone in close contact with the inner surface of the bag, and then the liquid containing acetone and lubricant was extracted from the bag.

The extracted liquid was applied to a gas chromatograph system, and the lubricant species and the lubricant amount contained in the liquid were determined from the detection data by a calibration curve method.

### (Surface Glossiness)

The surface glossiness (GU value) was measured at a 60° reflection angle using BYK's micro-TRI-gloss-s as a measuring instrument.

### (Tape Adhesiveness)

A test piece of 15 mm wide×150 mm long was cut from the battery packaging material. An adhesive tape (tesa 70415) of 5 mm width×80 mm length with an adhesive force of 13 N/cm was attached to the lubricant layer (substrate protective layer in Comparative Example 4) of the test piece along the longitudinal direction of the test piece. Then, a hand roll of 2 kgf in weight was run back and forth 5 times on this adhesive tape and then allowed to stand for 1 hour at normal temperature.

Next, a Shimadzu Strograf (AGS-5kNX) was used as a tensile testing machine, and one chuck was used to clamp and fix the end of the test piece, while the other chuck was used to grip the end of the adhesive tape. Then, the peel strength was measured when the tape was peeled 180° at a peel speed of 300 mm/min in accordance with JIS K6854-3 (1999), and the value at which this measurement value stabilized was used as the adhesive force (unit: N/5 mm) between the test piece and the adhesive tape.

Then, the adhesive force between the test piece and the adhesive tape was evaluated criteria as follows.
A: Very high in adhesiveness: 7 N/5 mm or more
B: High in adhesiveness: 5 N/5 mm or more and less than 7 N/5 mm
D: Low in adhesiveness: less than 5 N/5 mm

### (Appearance After Tape Peeling)

A test piece of 15 mm wide×150 mm long was cut from the battery packaging material. An adhesive tape (tesa 70415) of 5 mm width×80 mm length with an adhesive force of 13 N/cm was attached to the lubricant layer (substrate protective layer in Comparative Example 4) of the test piece along the longitudinal direction of the test piece. Then, a hand roll of 2 kgf in weight was run back and forth 5 times on this adhesive tape and then allowed to stand for 1 hour at normal temperature.

Next, the samples were placed for 1 d (24 h) in a vacuum dryer with a chamber temperature of 80° C.×gauge pressure of −100 kPa, heat pressed at 80° C. for 3 h under 500 kg/m², and then placed in a thermostatic chamber at 45° C. for 2 d (48 h) for processing conditions.

The adhesive tape was quickly removed by hand from the treated test piece, and the removed surface was observed and evaluated using the following evaluation criteria.
A: No change at all in the surface condition compared with before adhering the tape
B: Small fragments of adhesive residue that could be removed by lightly wiping.
C: Adhesive residue could be wiped off, but larger fragments of the adhesive than the fragments shown with B remained
D: Adhesive remained firmly to the degree that it could not be removed by wiping.

TABLE 1

| | Substrate protective layer | | | | | | | | | Heat-fusible | | |
|---|---|---|---|---|---|---|---|---|---|---|---|---|
| | Resin composition | | | | | | | Lubrication | | resin layer | | |
| | | Curing agent | | | | | | layer | | Lubricant | | |
| | | Parts by | Solid particles | | Young's | Tensile | Glossi- | | Abun- | concen- | Tape | Appearance |
| | Resin | mass | | Content | modulus | strength | ness | Lubri- | dance | tration | adhesive- | after tape |
| | composition | Note 1) | Type | Mass % | MPa | MPa | GU | cant | mg/m² | ppm | ness | peeling |
| Ex. 1 | PU | 10 | Silica | 20 | 180 | 10 | 4.7 | EA | 3 | 1,000 | A | A |
| Ex. 2 | PU | 5 | Silica | 60 | 70 | 5 | 2.1 | EA | 3 | 1,000 | A | A |
| Ex. 3 | PU | 7 | Silica | 55 | 100 | 8 | 2 | EA | 3 | 1,000 | A | A |
| Ex. 4 | PU | 17 | Silica | 5 | 250 | 15 | 5.8 | EA | 3 | 1,000 | A | A |
| Ex. 5 | PU | 20 | Silica | 0.2 | 280 | 19 | 6.2 | EA | 3 | 1,000 | A | B |
| Ex. 6 | PU | 17 | Silica | 10 | 240 | 13 | 5.5 | EA | 3 | 1,000 | A | A |
| Ex. 7 | PU | 8 | Silica | 40 | 130 | 9 | 3.5 | EA | 3 | 1,000 | A | A |
| Ex. 8 | PU | 5 | Silica | 65 | 60 | 7 | 1.8 | EA | 3 | 1,000 | B | C |
| Ex. 9 | PU | 8 | Silica | 20 | 150 | 10 | 4.7 | EA | 3 | 1,000 | A | A |
| Ex. 10 | UPh | 10 | Silica | 20 | 260 | 10 | 4.6 | EA | 3 | 1,000 | A | A |
| Ex. 11 | PU | 10 | Acryl | 20 | 180 | 10 | 4.3 | EA | 3 | 1,000 | A | A |
| Ex. 12 | PU | 10 | Silica | 20 | 180 | 10 | 4.7 | OA | 8 | 4,500 | B | A |
| Ex. 13 | PU | 10 | Silica | 20 | 180 | 10 | 4.7 | AN | 1 | 700 | A | A |
| Ex. 14 | PU | 10 | Silica | 20 | 180 | 10 | 4.7 | — | — | — | A | B |
| Comp. Ex. 1 | PU | 1 | Silica | 20 | 10 | 4 | 4.7 | EA | 3 | 1,000 | A | D |
| Comp. Ex. 2 | PU | 30 | Silica | 20 | 500 | 25 | 4.7 | EA | 3 | 1,000 | A | D |
| Comp. Ex. 3 | EP | 10 | Silica | 20 | 1,500 | 30 | 4.7 | EA | 3 | 1,000 | A | D |

Resin composition symbol: Polyester urethane (PU) Urethane phenoxy (UPh) Epoxy resin (EP)
Lubricant symbol: Erucicamide (EA) Oleamide (PU) Anionic acid surfactant (AN)
Note 1)
Amount of the curing agent with respect to 100 parts by mass of the base resin

From Table 1, it was confirmed that the adhesiveness of the protective tape is good and the adhesive residue after peeling can be suppressed by the physical properties of the substrate protective layer.

### [Aspects]

It would be understood by those skilled in the art that the exemplary embodiments described above are specific examples of the following aspects.

### [Item 1]

[1] According to an embodiment of the present disclosure, a battery packaging material includes a substrate protective layer; a substrate layer, a barrier layer, and a heat-fusible resin layer. The substrate protective layer, the substrate layer, the barrier layer, and the heat-fusible resin layer are laminated in this order. The substrate protective layer is composed of a resin composition containing a resin component and solid fine particles. Young's modulus of the substrate protective layer measured by a method specified in JIS K7127 is 50 MPa to 300 MPa, and tensile strength at 40% elongation measured by a method specified in JIS K7127 is 5 MPa to 20 MPa.

In the embodiment of the battery packaging material as recited in the above-described Item [1], the Young's modulus and the tensile strength at 40% elongation of the substrate protective layer are set within respective predetermined ranges. Therefore, the substrate protective layer is not prone to surface cracking due to excessive hardness, so the adhesive of the protective tape does not permeate into=cracked portions. Therefore, adhesive residue is unlikely to occur when peeling off the protective tape. Further, the adhesiveness with the protective tape does not become excessively high due to excessive softness, and therefore, film peeling is not likely to occur when peeling off the protective tape. Therefore, it is possible to acquire contradictory characteristics that the protective tape does not peel off unintentionally and that the protective tape can be peeled off without leaving adhesive residue of the protective tape.

### [Item 2]

[2] According to an embodiment of the present disclosure, in the battery packaging material as recited in the above-described Item 1, surface glossiness of the substrate protective layer may be 6.0 GU or less.

In the embodiment of the battery packaging material as recited in the above-described Item [2], surface glossiness of the substrate protective layer is 6.0 GU or less, so continuous unevenness is formed on the surface of the substrate protective layer. Therefore, the protective tape comes into contact with the protrusions but are separated at the recesses, which reduces the effective contact area with the substrate protective layer of the protective tape. As a result, the peelability of the protective tape is improved, resulting in less adhesive residue.

### [Item 3]

[3] According to an embodiment of the present disclosure, in the battery packaging material as recited in the above-described Item 1 or 2, a content of the solid fine particles in the substrate protective layer may be 0.1 mass % to 60 mass %.

In the embodiment of the battery packaging material as recited in the above-described Item [3], the content of the solid fine particles contained in the substrate protective layer is 0.1 mass % to 60 mass %, so desired surface glossiness can be achieved. [Item 4]

[4] According to an embodiment of the present disclosure, in the battery packaging material as recited in any one of the above-described Items 1 to 3, an average particle diameter of the solid fine particles contained in the substrate protective layer may be 1 μm to 10 μm.

In the embodiment of the battery packaging material as recited in the above-described Item [4], the average particle diameter of the solid fine particles contained in the substrate protective layer is 1 μm to 10 μm. Therefore, desired surface glossiness can be attained, and the solid fine particles are less likely to drop off from the substrate protective layer.

### [Item 5]

[5] According to an embodiment of the present disclosure, in the battery packaging material as recited in any one of the above-described Items 1 to 4, the substrate protective layer may contain a lubricant.

In the embodiment of the battery packaging material as recited in the above-described Item [5], the lubricant contained in the substrate protective layer precipitates on the surface of the substrate protective layer, forming a lubricant layer on the surface of the substrate protective layer. This lubricant layer results in easy peeling of the protective tape, thereby causing less adhesive residue.

[6] According to an embodiment of the present disclosure, in the battery packaging material as recited in any one of the above-described Items 1 to 5, a lubricant layer composed of a lubricant may be formed on a surface of the substrate protective layer.

In the embodiment of the battery packaging material as recited in the above-described Item [6], the lubricant layer composed of a lubricant is formed on the surface of the substrate protective layer, so a protective tape can be easily peeled off, thereby causing less adhesive residue.

### [Item 7]

[7] According to an embodiment of the present disclosure, in the battery packaging material as recited in the above-described Item 6, a lubricant amount of the lubricant layer may be 1.0 mg/m² to 10.0 mg/m².

In the embodiment of the battery packaging material as recited in the above-described Item [7], the lubricant amount of the lubricant layer is 1.0 mg/m² to 10.0 mg/m², and therefore, the peeling property of a protective tape is good, thereby causing less adhesive residue.

[8] According to an embodiment of the present disclosure, in the battery packaging material as recited in any one of the above-described Items 1 to 7, the heat-fusible resin layer may contain a lubricant.

In the embodiment of the battery packaging material as recited in the above-described Item [8], the lubricant contained in the heat-fusible resin layer precipitates on the surface, and by transferring the lubricant to the surface of the substrate protective layer, a lubricant layer is formed. This lubricated layer causes easy protective tape peeling, resulting in less adhesive residue.

[9] According to an embodiment of the present disclosure, a battery includes:
a bare cell, and
a battery case made of the battery packaging material as recited in any one of the above-described Items 1 to 8,
wherein the bare cell is encapsulated in the battery case, and
wherein the battery case is formed by heat-sealing peripheral portions of a pair of the battery packaging materials stacked one on the other with the heat-fusible resin layers faced each other.

According to the embodiment of the battery as recited in the above-described Item [9], it is possible to provide a battery capable of acquiring contradictory characteristics that the protective tape does not peel off unintentionally and that the protective tape can be peeled off without leaving adhesive residue of the protective tape.

It should be recognized that the terms and expressions used herein are for illustrative purposes only, are not to be construed as limiting, do not exclude any equivalents of the features shown and described herein, and allow for various variations within the claimed scope of this invention. It should be recognized that the invention does not exclude any equivalents of the features shown and described herein, but permits various variations within the claimed scope.

### INDUSTRIAL APPLICABILITY

The battery packaging materials according to the above-described embodiments can be suitably used as a packaging case for a secondary battery for, for example, an automotive use, a stationary use, a laptop computer, a cellular phone, or a camera, especially suitable used as a small portable lithium-ion secondary battery.

### DESCRIPTION OF REFERENCE SYMBOLS

1, 2: Battery packaging material
11: Barrier layer
12: First adhesive layer
13: Substrate layer
14: Second adhesive layer
15: Heat-fusible resin layer
30: Substrate protective layer
40: Lubricant Layer

1. A battery packaging material comprising:
a substrate protective layer;
a substrate layer;
a barrier layer; and
a heat-fusible resin layer,
wherein the substrate protective layer, the substrate layer, the barrier layer, and the heat-fusible resin layer are laminated in this order,
wherein the substrate protective layer is composed of a resin composition containing a resin component and solid fine particles, and
wherein Young's modulus of the substrate protective layer measured by a method specified in JIS K7127 is 50 MPa to 300 MPa, and tensile strength at 40% elongation measured by a method specified in JIS K7127 is 5 MPa to 20 MPa.

2. The battery packaging material as recited in claim 1,
wherein surface glossiness of the substrate protective layer is 6.0 GU or less.

3. The battery packaging material as recited in claim 1,
wherein a content of the solid fine particles in the substrate protective layer is 0.1 mass % to 60 mass %.

4. The battery packaging material as recited in claim 1,
wherein an average particle diameter of the solid fine particles contained in the substrate protective layer is 1 μm to 10 μm.

5. The battery packaging material as recited in claim 1,
wherein the substrate protective layer contains a lubricant.

6. The battery packaging material as recited in claim 1,
wherein a lubricant layer composed of a lubricant is formed on a surface of the substrate protective layer.

7. The battery packaging material as recited in claim 6,
wherein a lubricant amount of the lubricant layer is 1.0 mg/m² to 10.0 mg/m².

8. The battery packaging material as recited in claim 1,
wherein the heat-fusible resin layer contains a lubricant.

9. A battery comprising:
a bare cell; and
a battery case made of the battery packaging material as recited in claim 1,
wherein the bare cell is encapsulated in the battery case, and
wherein the battery case is formed by heat-sealing peripheral portions of a pair of the battery packaging materials stacked one on the other with the heat-fusible resin layers faced each other.
